(19) United States
(12) Patent Application Publication
(10) Pub. No.: US 2008/0021830 A1
(43) Pub. Date: Jan. 24, 2008

(54) SYSTEM AND METHOD OF PROCESSING ACCOUNTS RECEIVABLE AND BANKING INTEGRATION

(75) Inventor: Annette K. Apergis, Glen Head, NY (US)

Correspondence Address: LOCKE LORD BISSELL & LIDDELL LLP;ATTN: IP DOCKETING, 600 TRAVIS, SUITE 3400, HOUSTON, TX, 77002-3095, US

(73) Assignee: NEW AGE TECHNOLOGIES, INC., Rosedale, NY (US)

(21) Appl. No.: 11/458,543

(22) Filed: Jul. 19, 2006

(51) Int. Cl. G06Q 40/00

(52) U.S. Cl. 705/45

(57) ABSTRACT

A system and method for processing account receivable related to at least one check and a banking integration system based thereon, wherein each check contains customer identification, including an accounting database containing customer data including balance information; a remote deposit access scanner capable scanning the checks to locate customer identification on each check; a program capable of automatically matching the customer identification to the customer data; a program capable of posting the customer identification to a Customer Account Information; and a program capable of modifying the balance information.

### CROSS REFERENCE TO RELATED APPLICATIONS

Not applicable.

### STATEMENT REGARDING FEDERALLY SPONSORED RESEARCH OR DEVELOPMENT

Not applicable.

### REFERENCE TO APPENDIX

Not applicable.

### BACKGROUND OF THE INVENTION

1. Field of the Invention

This disclosure relates generally to a processing checks, and more particularly to the processing of checks for accounts receivable purposes.

2. Description of the Related Art

In order to process a check for accounts receivable purposes, the following occurs as illustrated in FIG. 1 (Prior Art). The checks are received in Step 1 and deposited. There are several ways to deposit the checks. First, a deposit slip is manually prepared for deposit in Step 2 and checks are deposited at the physical branch/location in Step 3.

In the alternative, a tape is manually prepared and attached to a deposit slip in Step 4, which is in turn deposited at the bank's physical location in Step 3. Or the received checks of Step 1 are scanned into Remote Deposit Access hardware in Step 5. This feature creates an image of the check, stores the check data and creates a cash letter that is transferred to the bank in Step 6. The received checks of Step 1 are also scanned into some other hardware acceptable or used by the Depository Institution for the Automated Clearing House (ACH) and/or the creation of a Cash Letter in Step 7. This Cash Letter or Depository Institution for the ACH is transmitted to the bank in Step 8. The bank credits funds to a checking account in Step 9.

After Step 3, 5 or 7, the checks are then entered into the accounting software used by the User in Step 10. The User is typically a customer of the bank. The deposit is then posted to the User's appropriate customer and trial balance accounts in Step 11. Once the deposit information is in the accounting system, the User reconciles the checks posted to open invoices in the customer account in Step 12.

The current process is very time consuming for those organizations that receive hundreds of checks on a daily basis, including mortgage servicers, distributors, manufacturers and similar entities. Therefore, a need exists to reduce the time associated with processing accounts receivable and for allowing for more efficient and effective work to be preformed, such as reconciliation of customer accounts and similar activities.

### BRIEF SUMMARY OF THE INVENTION

Therefore, a need exists to reduce the time needed for these organizations that receive hundreds of checks on a daily basis to reduce the time associated with processing accounts receivable and for allowing for more efficient and effective work to be preformed. The present invention provides a system and method to process these accounts receivable and aid in banking integration.

A system and method for processing account receivable related to at least one check and a banking integration system based thereon, wherein each check contains customer identification, including an accounting database containing customer data including balance information; Remote Deposit Access software and hardware or other a remote deposit access scanner, which is a scanner capable of scanning the checks to locate customer identification on each check; a program capable of automatically matching the customer identification to the customer data; a program capable of posting the customer identification to a Customer Account Information; and a program capable of modifying the balance information. The system and method preferably include an input module capable of allowing a user to manually input a Customer Account Number or a Customer Name, invoice, purchase order, sales order, or delivery shipment order. Customer identification may include ABA Routing Number, Checking Account Number, account number, customer name, or any other information that identifies the customer to the check, such as Customer Account Number or a Customer Name, invoice, purchase order, sales order, or delivery shipment order. The system and method use preferably include the Remote Deposit Access scanner or another scanner capable of generating an image of the check, preferably wherein each check is received and processed to create a Cash Letter and/or each check is received and processed through an Automated Clearing House transaction.

### BRIEF DESCRIPTION OF THE DRAWINGS

FIG. 1 is a flow diagram that illustrates a prior art version of the processing of the accounts receivable.

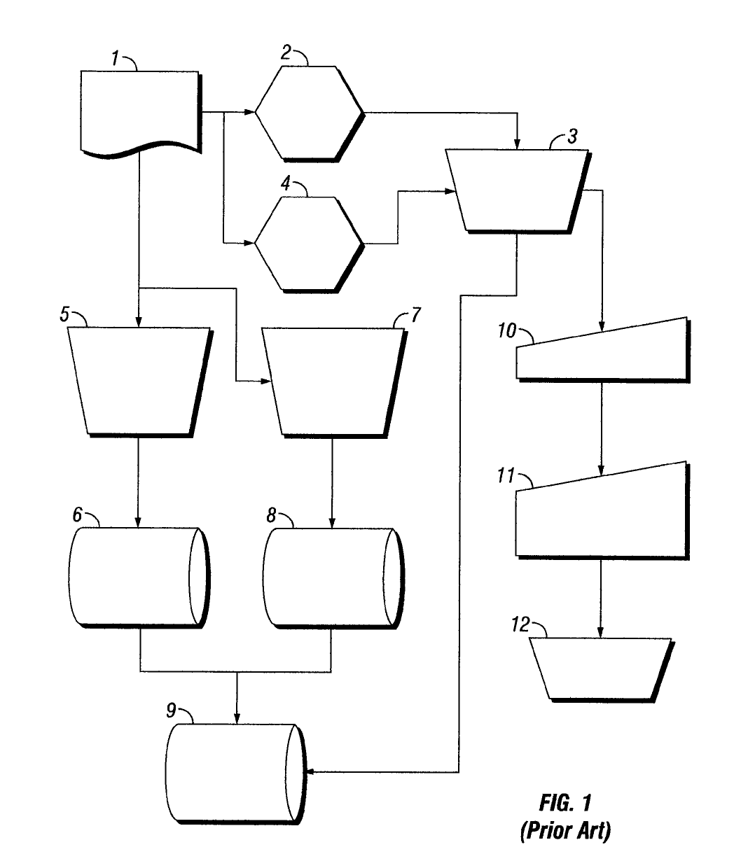

FIG. 2 is a flow diagram that illustrates one embodiment of the present invention.

FIG. 3 is a flow diagram that illustrates one embodiment of the present invention.

While the inventions disclosed herein are susceptible to various modifications and alternative forms, only a few specific embodiments have been shown by way of example in the drawings and are described in detail below. The figures and detailed descriptions of these specific embodiments are not intended to limit the breadth or scope of the inventive concepts or the appended claims in any manner. Rather, the figures and detailed written descriptions are provided to illustrate the inventive concepts to a person of ordinary skill in the art and to enable such person to make and use the inventive concepts.

### DETAILED DESCRIPTION

One or more illustrative embodiments incorporating the invention disclosed herein are presented below. Not all features of an actual implementation are described or shown in this application for the sake of clarity. It is understood that in the development of an actual embodiment incorporating the present invention, numerous implementation-specific decisions must be made to achieve the developer's goals, such as compliance with system-related, business-related, government-related and other constraints, which vary by implementation and from time to time. While a developer's efforts might be complex and time-consuming, such efforts would be, nevertheless, a routine undertaking for those of ordinary skill the art having benefit of this disclosure.

The present invention provides for a system and method of its use containing a software component program to interface between the Remote Deposit Access software and database or other databases that transmit an ACH or Cash Letter to the respective bank and information to the Users Accounting System. In this scenario the User is defined as a customer of the bank using the Remote Deposit Access system or other check scanning hardware that transmits an ACH or Cash Letter to the respective bank.

In order to process a check for accounts receivable purposes one of the following needs to occur.

### 1. The checks are received and processed through a Remote Deposit Access feature which then creates a cash letter that is transferred to the bank.

### 2. The checks are processed through an ACH transaction.

### 3. The checks are processed through any other check scanning hardware that transmits an ACH or Cash Letter.

As a replacement for the manual data entry that currently occurs, the Program may match the ABA Routing Number and the Checking Account Number stored in the database to the ABA Routing Number and Checking Account Number located in the Customers Account information in the Users Accounting System.

Once the Program confirms the ABA and Account Number match, the Program will automatically post the check, including amount and check number, to the Customers Account and the Trial Balance, such as Income and Accounts Receivable accounts. The information is then removed from the Program database.

If the Program cannot confirm the ABA and Account Number, the information remains in the database. The User is required to do one of the following:

1. Upload the Customer Account information into the database. Once the information is uploaded the User selects the account.
2. The User inputs the Customer Account Number, the Customer Name, or any other information recognized by the Program. The Program will match the additional information to the Customers Account information in the Users Accounting System.

The check posts to the account, the ABA and Account Number are auto posted to the appropriate fields in the Customer Account Information and the information is removed from the database.

If the Program cannot confirm the additional information, the information remains in the database. The User is required to perform the existing application.

In a preferred embodiment, the present invention requires than the Users use a Remote Deposit Access, ACH or any other type of system that transmits an ACH or Cash Letter to the respective bank and stores the information to a database. This embodiment preferably requires that the Users Accounting System must provide a minimum of two fields in the Customer Account Information in order to input the Customers ABA and Checking Account Number.

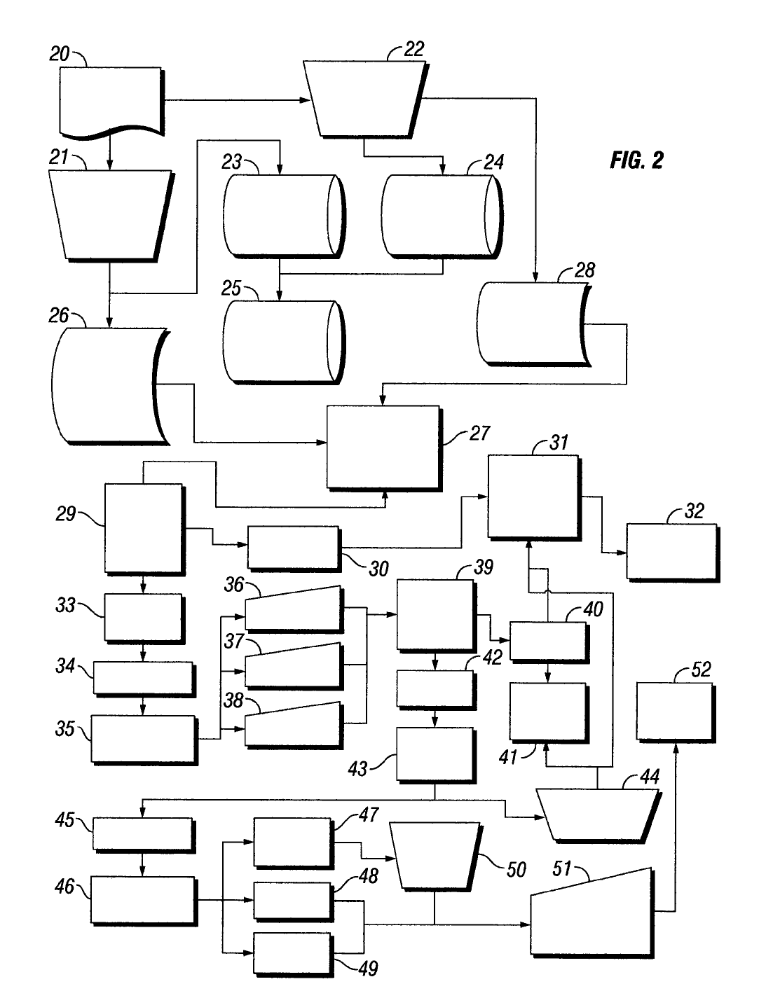

FIG. 2 shows this embodiment. As shown, checks are received in Step 20. The received checks of Step 20 are scanned into the Remote Deposit Access hardware of Step 21. The receive checks of Step 20 may also be scanned into some other hardware accepted or used by the Depository Institution for ACH and/or the creation of a Cash Letter in Step 22.

The scanned checks of Step 21 are created into a Cash Letter in Step 23. Respectively, the Cash Letter/ACH from Step 22 is transmitted to the bank in Step 24. The Cash Letter of Step 23 and/or the Cash Letter/ACH of Step 24 are used by the bank to credit funds to the checking account in Step 25.

The scanned checks of Step 21 data that is stored in the Remote Deposit Access database or some other database in Step 26. A program in Step 27 reads this data stored in the database and searches the accounting database.

The Cash Letter of Step 22 may also be stored as data in some other database in Step 28. Similarly, the program in Step 27 reads this data stored in the database and searches the accounting database.

The Program matches the customer American Bankers Association (ABA) number and account number to the information in the database in Step 29. If this information is verified in Step 30, the check is posted to the appropriate customer and trial balance accounts in Step 31. From there, the information is removed from the database in Step 32.

If this information is not verified in Step 33, the information remains in the database in Step 34. The Program informs the user that it needs more information to attach the check to the customer account in Step 35.

At this point three steps may occur. The User inputs the customer account number in Step 36. The User inputs the customer name in Step 37. The User inputs any other information to recognize the customer in Step 38.

If the User inputs the customer account number in Step 36, inputs the customer name in Step 37, or inputs any other information to recognize the customer in Step 38, the Program matches the additional information to the Customer Account in Step 39. If this information is verified in Step 40, the ABA and account number are auto posted to the customer's account in Step 41. The check is posted to the appropriate customer and trial balance accounts in Step 31 and removed from the database in Step 32.

If the information is not verified in Step 42, the Customer Account information is uploaded from the accounting database to the database in Step 43.

The User views the check and selects the customer from the uploaded data in Step 44. This check is sent posted as described in Step 31, removed from the database in Step 32 and the account info is posted as described in Step 41.

If the information does not exist in Step 45, the check is posted to an Unapplied Customer Suspense Account in Step 46. From this step, an image of the check is saved in an Unapplied Suspense Account folder located on the Users network in Step 47, the User gets a copy of the check in Step 48, or the User gets the physical check in Step 49.

From the image of the check saved in an Unapplied Suspense Account folder located on the Users network in Step 47, the User accesses the scanned copy of the check in Step 50. Then, the User takes the check information and appropriately posts the check to correct customer and trial balance accounts in Step 51. From this point, the information is manually removed from the database as shown in Step 52.

In an alternative embodiment, software component Program to interface between the Remote Deposit Access database or other databases that transmit an ACH or Cash Letter to the respective bank and the Users Accounting System. In this scenario the User is defined as a customer of the bank using the Remote Deposit Access system or other check scanning hardware that transmits an ACH or Cash Letter to the respective bank.

In order to process a check for accounts receivable purposes, one of the following needs to occur.

### 1. The checks are received and processed through a Remote Deposit Access feature which then creates a cash letter that is transferred to the bank.

### 2. The checks are processed through an ACH transaction.

### 3. The checks are processed through any other check scanning hardware that transmits an ACH or Cash Letter.

As an alternative for the above, the Program, will upload the Customer Account Information to the database. As the checks are scanned the User selects the Customer Account. The check posts to the account and the information is removed from the database.

It is preferred that the Users use a Remote Deposit Access, ACH or any other type of system that transmits an ACH or Cash Letter to the respective bank and stores the information to a database. Additionally, it is recommended that the Users Accounting System must provide a minimum of two fields in the Customer Account Information in order to input the Customers ABA and Checking Account Number.

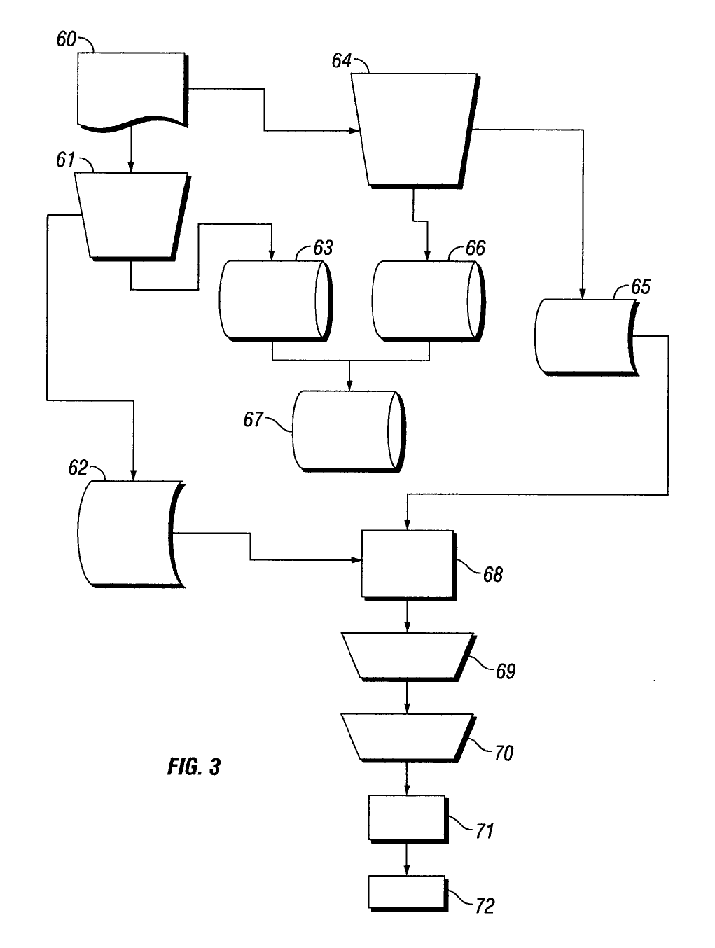

As illustrated in FIG. 3, checks are received in Step 60. The checks may be scanned into the Remote Deposit Access hardware in Step 61. Data is stored in the Remote Deposit Access or other database in step 62 and a Cash Letter is transmitted to the bank in Step 63.

The checks may be scanned into some other hardware acceptable or used by the Depository Institution for ACH and/or creation of a Cash Letter in Step 64. The data is stored in some other database on Step 65 and a Cash Letter/ACH is transmitted to the bank in Step 66.

When the bank receives the Cash Letter or Cash Letter/ACH from Steps 63 or 66, respectively, the bank credits finds to a checking account in Step 67. Next, the Customer Account information and invoices are uploaded to the database in Step 68. The User views the check and selects the customer from the uploaded data in Step 69.

The User selects the invoices to reconcile the check with the customer's account in Step 70. The check is posted to the appropriate customer and trial balance accounts in Step 71. Finally, information is removed from the database in Step 72.

The invention has been described in the context of preferred and other embodiments and not every embodiment of the invention has been described. Obvious modifications and alterations to the described embodiments are available to those of ordinary skill in the art. The disclosed and undisclosed embodiments are not intended to limit or restrict the scope or applicability of the invention conceived of by the Applicants, but rather, in conformity with the patent laws, Applicants intends to protect all such modifications and improvements to the full extent that such falls within the scope or range of equivalent of the following claims.

What is claimed is:

1. A system for processing account receivable related to at least one check, wherein each check contains customer identification, comprising:
an accounting database containing customer data including balance information;
a remote deposit access scanner capable scanning the checks to locate customer identification on each check;
a program capable of automatically matching the customer identification to the customer data;
a program capable of posting the customer identification to a Customer Account Information; and
a program capable of modifying the balance information.

2. The system of claim 1 further comprising an input module capable of allowing a user to manually input a Customer Account Number or a Customer Name.

3. The system of claim 1 wherein the customer identification is selected from the group consisting of ABA Routing Number and Checking Account Number.

4. The system of claim 1 wherein each check is received and processed through a Remote Deposit Access feature wherein the remote deposit access scanner is capable of generating an image of the check to create a Cash Letter.

5. The system of claim 1 wherein each check is received and processed through an Automated Clearing House transaction.

6. A method of processing accounts receivable, which comprises the Steps of:
receiving at least one check;
processing the check through a Remote Deposit Access or Automatic Clearing House feature;
creating a cash letter;
transferring the Cash Letter to a bank
scanning the check to recognize at least one customer identification;
confirming the customer identification automatically; and
posting the check.

7. The method of claim 6 wherein the customer identification is a Routing Number.

8. The method of claim 6 wherein the customer identification is an Account Number.

9. The method of claim 6 further comprising allowing user input of an Account Number or a Customer Name.

10. The method of claim 6 further comprising allowing user input of an Account Number and an American Bankers Association number.

11. The method of claim 6 further comprising processing the check through an Automated Clearing House transaction.

12. A method of banking integration by processing accounts receivable, which comprises the Steps of:
receiving a plurality of checks;
processing the checks through a Remote Deposit Access or Automatic Clearing House feature;
creating cash letters;
transferring the Cash Letters to at least one bank
scanning the checks to recognize at least one customer identification for each check;
confirming the customer identification automatically for each check; and
posting the checks.

13. The method of claim 12 wherein the customer identifications are a Routing Numbers.

14. The method of claim 12 wherein the customer identifications are an Account Numbers.

15. The method of claim 12 further comprising allowing user inputs of Account Numbers or Customer Names.

16. The method of claim 12 further comprising allowing user inputs of Account Numbers and American Bankers Association numbers.

17. The method of claim 12 further comprising processing the checks through Automated Clearing House transactions.
